(19) United States
(12) Patent Application Publication
(10) Pub. No.: US 2016/0333843 A1
(43) Pub. Date: Nov. 17, 2016

(54) MOTOR VEHICLE HEAT EXCHANGER SYSTEM

(71) Applicant: BENTELER AUTOMOBILTECHNIK GMBH, Paderborn (DE)

(72) Inventors: FELIX RUBITSCHEK, Paderborn (DE); SVEN PRZYBYLSKI, Paderborn (DE); ANATOLI ENNS, Paderborn (DE); TOBIAS DÜPMEIER, Paderborn (DE)

(73) Assignee: BENTELER AUTOMOBILTECHNIK GMBH, Paderborn (DE)

(21) Appl. No.: 15/152,174

(22) Filed: May 11, 2016

(30) Foreign Application Priority Data
May 12, 2015 (DE) 10 2015 107 468.0

(51) Int. Cl. F02N 19/04; F01N 5/02; B60K 13/04

(52) U.S. Cl. CPC F02N 19/04; B60K 13/04; F01N 5/02; F16H 57/0415

(57) ABSTRACT

A motor vehicle heat exchanger system includes a closed circuit for a working medium and an exhaust gas channel for passage of exhaust gas that is discharged from an internal combustion engine of the motor vehicle. An evaporator makes contact with the exhaust gas channel and evaporates the working medium. The evaporator includes at least one evaporator cassette having a housing and a capillary structure arranged in the housing. The capillary structure is formed by a porous plate body, e.g. made of sintered material.

### CROSS-REFERENCES TO RELATED APPLICATIONS

This application claims the priority of German Patent Application, Serial No. 10 2015 107 468.0, filed May 12, 2015, pursuant to 35 U.S.C. 119(a)-(d), the disclosure) of which is incorporated herein by reference in its entirety as if fully set forth herein.

### BACKGROUND OF THE INVENTION

The present invention relates to a motor vehicle heat exchanger system.

The following discussion of related art is provided to assist the reader in understanding the advantages of the invention, and is not to be construed as an admission that this related art is prior art to this invention.

Against the backdrop of increasingly scarce fossil resources and legal requirements with regard to CO₂ emissions from motor vehicles, measures to increase the overall efficiency of motor vehicles are becoming ever more important. About two-thirds of the chemically bound energy to drive a motor vehicle is lost in the form of combustion heat and frictional heat. There have therefore been efforts for a long time to better utilize the exhaust gas heat and to use it to increase the efficiency of motor vehicles. In addition to concepts for direct energy recovery (thermoelectrics, Rankine), measures provide, in conjunction with the thermal management of motor vehicles for example, options to use waste heat for interior heating or the shortening of cold-start phases. Thus, the shortening of cold-start phases by an accelerated warm-up of lubricants, such as motor or transmission oil, can take place, whereby a reduction of friction loss can be obtained.

DE 10 2011 103 110 B4 discloses an exhaust gas system for an internal combustion motor of a motor vehicle with a circulation heat pipe. The exhaust gas system has an exhaust gas pipe, a condenser, and an evaporator, as well as lines connecting the condenser and the evaporator. Heat transport of the heat energy extracted from the exhaust gas takes place via a working medium. The evaporator is formed of an exhaust gas pipe, a capillary structure and a cladding tube. The capillary structure is constructed as a porous body between the exhaust gas pipe and the enveloping body, in which the working medium crosses over from a fluid state into a gas or rather vapor state when passing through the capillary structure.

The heat pipe works simply by introduction of heat without mechanical pumping of the working medium. This is possible through the use of a capillary structure in the evaporator, which compensates for the flow pressure loss of the working medium through the capillary pressure. The heat pipe is generally constructed concentrically with an internal gas guide or rather internal bypass. This leaves only a one-sided heat dissipation from the inside to the outside. The manufacture of tubular capillary structures also takes considerable effort.

It would therefore be desirable and advantageous to provide an improved motor vehicle heat exchanger system which obviates prior art shortcomings and which is simple in construction and lightweight while yet being reliable in operation.

### SUMMARY OF THE INVENTION

According to one aspect of the present invention, a motor vehicle heat exchanger system includes a closed circuit for a working medium, an exhaust gas channel configured to conduct exhaust gas from an internal combustion engine of a motor vehicle, and an evaporator configured to contact the exhaust gas channel for evaporating the working medium, the evaporator including at least one evaporator cassette which includes a housing and a capillary structure arranged in the housing.

In accordance with the present invention, the motor vehicle heat exchanger system has a closed circuit for a working medium. Integrated in the circuit is the evaporator, which is arranged in the exhaust gas stream of the internal combustion engine of the motor vehicle and achieves transfer of heat in contact with the exhaust gas. The exhaust gas discharged from the internal combustion engine of the motor vehicle can be wholly or partly passed through an exhaust gas channel. The working medium is evaporated in the evaporator and flows from there to a condenser arranged in the motor vehicle. There is heat transfer with a consumer in the condenser, where the vaporous working medium is condensed and liquefied. The liquid working medium is recycled in the evaporator via a return line.

According to the invention, the evaporator comprises at least one evaporator cassette, whereby the evaporator cassette has a housing and a capillary structure arranged in the housing.

Modularization and scaling is possible through cassette construction or plate-like construction. Furthermore, a large heat transfer surface can be realized in a compact space. The effective heat transfer surface can be varied via the size of the evaporator cassette. It is also possible to operate multiple evaporators or evaporator cassettes in parallel and thus to also configure the efficiency factor in certain operating points via the number of exhaust gas channels in addition to the performance.

According to another advantageous feature of the present invention, the at least one evaporator cassette can have a liquid side and a vapor side, which are separated by the capillary structure. The capillary structure may be formed by a porous plate body. Advantageously, the capillary structure can be made of sintered material. In particular, the capillary structure is based on metal.

In operation, the working medium can pass from the liquid side through the capillary structure and thereby evaporates. The phase boundary between the liquid and vapor during operation of the evaporator takes place in the capillary structure, through which capillary pressure is built up, which causes or guarantees the circulation of the working medium. On the vapor side, the working medium exits from the capillary structure in the gaseous or vaporous state. From here, the vaporous working medium is discharged or forwarded in the circuit.

Manufacture of the capillary structure is particularly advantageous. The capillary structure can be manufactured separately. Advantageously, the capillary structure can be sintered from a loose metallic bulk powder. This allows different geometric configurations of the capillary structure. Furthermore, vapor channels can be integrated directly into the sinter form. Advantageously, the vapor channels necessary for vapor guidance can be integrally formed in one piece in the capillary structure.

It is also possible to design the capillary structure as a metallic random non-woven fabric.

The housing can be made of a corrosion resistant material and/or good heat-conducting material, in particular a metal, preferably steel, in particular a stainless steel.

According to another advantageous feature of the present invention, the capillary structure can have formed therein vapor channels. Advantageously, the vapor channels can be provided on the vapor side in the surface of the capillary structure facing the exhaust gas channel.

Advantageously, the evaporator or each evaporator cassette can be associated with a vapor collection chamber in which the vapor flowing from the evaporator or the evaporator cassette is collected and is fed from there to the condenser.

According to another advantageous feature of the present invention, the evaporator may include a plurality of evaporator cassettes. The evaporator cassettes may be connected and joined to each other in a modular manner so that a passage for exhaust, which comes from the internal combustion engine of the motor vehicle, can be formed respectively between adjacent evaporator cassettes. Accordingly, the exhaust gas channel or plurality of exhaust gas channels can be formed respectively between two adjacent evaporator cassettes joined to one another.

According to another advantageous feature of the present invention, a structure may be received in the exhaust gas channel to enlarge a heat transfer surface. As a result, the efficiency of heat transfer from the hot exhaust gas to the working medium can be increased. Advantageously, the structure to enlarge the heat transfer surface can be designed as ribs, webs or fins. In practice, the use of stainless steel sheet lamella is considered beneficial for this purpose. The presence of such a structure promotes the exhaust gas side heat transfer from the exhaust gas flow to the working medium.

The evaporator cassette can be configured rectangular plate-shaped. In a simple construction, the housing may include a housing shell or panel which is closed by a lid. The connections necessary for both the working medium and pressure equalization are integrated in the lid or on the lid. The capillary structure can be incorporated into the interior of the evaporator cassette, which is also configured rectangular plate-shaped. This embodiment is advantageous in a production-oriented manner. The same applies to the space required and the weight of the evaporator.

In terms of manufacture and production it is advantageous, when the housing, in particular the housing shell, and the lid as well as the end wails or end-facing panels are designed as sheet metal formed parts and/or punched parts. They can consequently be produced inexpensively on a large scale,

As stated above, the housing can be made of stainless steel. Beads and/or inward or outward stampings may be provided in the housing or part of the housing, in particular the lid or the housing shell. Such material transformations, such as beads, inward or outward stampings, can be provided for stiffening or increase in rigidity of the housing. Likewise, such beads, inward or outward stampings may be configured as connecting surfaces or flow channels.

Also beads in the housing, in particular in the bottom of the housing shell, can form vapor grooves. This vapor grooves act to channel or discharge the vapor on the vapor side of an evaporator cassette.

According to another advantageous feature of the present invention, a circumferential stamping or bead directed towards the interior of the shell body can be provided in the lid. The bead contacts the capillary structure on the liquid side, optionally under incorporation of a temperature-resistant seal. The intermediate space between the lid, the seal and the capillary structure serves as a distribution space for the fed liquid working medium.

Provision may further be made for bead-shaped inward or outward stampings in the housing shell, in particular in the bottom of the housing shell. For two adjacent evaporator cassettes, the cassettes abut along the beads to each other and limit the exhaust gas channel. The distance between the evaporator cassettes is determined by the geometric design, in particular the depth or height of the beads, thus defining the size of the exhaust gas channel.

According to another advantageous feature of the present invention, the capillary structure can be arranged under incorporation of seals in the housing. Especially high temperature resistant seals are, advantageously, used here, particularly seals based on graphite. The seal is designed for high temperatures of more than 200° C.

The capillary structure and the seal or the seals can be inserted loosely into the housing and frictionally held via the lid and housing shell. The housing shell and the lid can be integrally joined to one another, like the remaining components of the heat exchanger, such as connection lines as well as front and rear facing panels or sheets. Tightness of the heat exchanger cassette is ensured as is the tightness of the exhaust gas channel. Vacuum is used for a material joint, for example, welding, for example, furnace brazing. A plurality of joining points can be produced simultaneously by means of a furnace brazing process. Furthermore, the lid, housing shell and end panels may be joined by welding.

According to another advantageous feature of the present invention, an expansion tank for the working medium may be arranged upstream of the evaporator. In particular, the expansion tank can be integrated into the return line.

According to another advantageous feature of the present invention, pressure equalization can be provided in the system, particularly in the evaporator. The efficiency of the motor vehicle heat exchanger system according to the invention can be further increased in this way. For this purpose, the evaporator and the expansion tank can be connected to each other via a pressure equalization line. In this way, a lower pressure level is ensured in the circulation. By equalizing the pressure between the evaporator and expansion tank, the working direction of the circuit can be influenced, especially in the start-up behavior. Furthermore, stabilization of the temperature in the starting phase is possible as a result. Also, a system-beneficial high temperature difference between the vapor line and condenser performance is supported.

The manufacturing process of a capillary structure can be relatively simple compared to a cylindrical structure. The capillary structure can also be sturdy thanks to its plate-shaped design. Particularly advantageously, the vapor channels can be introduced directly into the capillary structure in the sintering process. Another important advantage can be that the sealing between the liquid side and the vapor side of the evaporator or evaporator cassette requires no difficult fit. The design of the evaporator cassette and in particular the capillary structure can therefore be error-tolerant with respect to form and position deviations.

### BRIEF DESCRIPTION OF THE DRAWING

Other features and advantages of the present invention will be more readily apparent upon reading the following description of currently preferred exemplified embodiments of the invention with reference to the accompanying drawing, in which:

FIG. 1 shows a perspective view of a heat exchanger of a motor vehicle heat exchanger system according to the present invention;

FIG. 2 shows a cross-section through a heat exchanger according to FIG. 1;

FIG. 3 shows the heat exchanger according to FIG. 1 in another perspective view, partially in a sectional view;

FIG. 4 shows a further embodiment of a heat exchanger according to the present invention in a perspective view;

FIG. 5 shows the heat exchanger according to FIG. 5 in a sectional view;

FIG. 6 shows the heat exchanger according to FIG. 3 in another perspective view, partially in a sectional view;

FIG. 7 shows a lower part of a sintering form for manufacturing a capillary structure; and

FIG. 8 shows the capillary structure of an evaporator cassette in a perspective view.

### DETAILED DESCRIPTION OF PREFERRED EMBODIMENTS

Throughout all the figures, same or corresponding elements may generally be indicated by same reference numerals. These depicted embodiments are to be understood as illustrative of the invention and not as limiting in any way. It should also be understood that the figures are not necessarily to scale and that the embodiments are sometimes illustrated by graphic symbols, phantom lines, diagrammatic representations and fragmentary views. In certain instances, details which are not necessary for an understanding of the present invention or which render other details difficult to perceive may have been omitted.

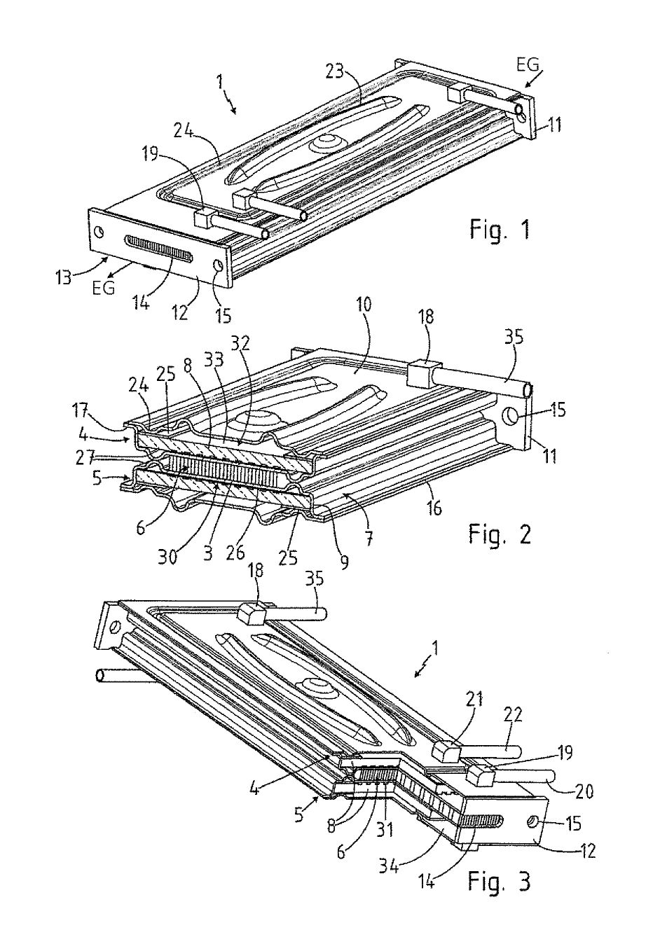

FIGS. 1-3 and FIGS. 4-6 each show an evaporator 1, 2 of a motor vehicle heat exchanger system according to the present invention. The evaporators 1, 2 are constructed identically, so that corresponding components or component parts are provided with the same reference numbers.

A motor vehicle heat exchanger system has a closed circuit for a working medium. The working medium, in particular, involves ethanol. A condenser, although not shown, is integrated in accordance with the present invention and includes the necessary connecting lines between evaporator 1, 2 and the condenser. The condenser as well as an expansion tank for the working medium are part of the motor vehicle heat exchanger system. The expansion tank, although not shown, is integrated in accordance with the present invention, and is connected upstream of the evaporator 1, 2.

Exhaust gas EG from the internal combustion engine of a motor vehicle is led through an exhaust gas channel 3 and achieves heat transfer in contact with the evaporator. The evaporator 1, 2 comprises two evaporator cassettes 4, 5 in the embodiment shown in FIGS. 1-6. The exhaust gas channel 3 is formed between the modularly joined evaporator cassettes 4, 5. The exhaust gas EG is thus led centrally through the exhaust gas channel 3 between the two evaporator cassettes 4, 5.

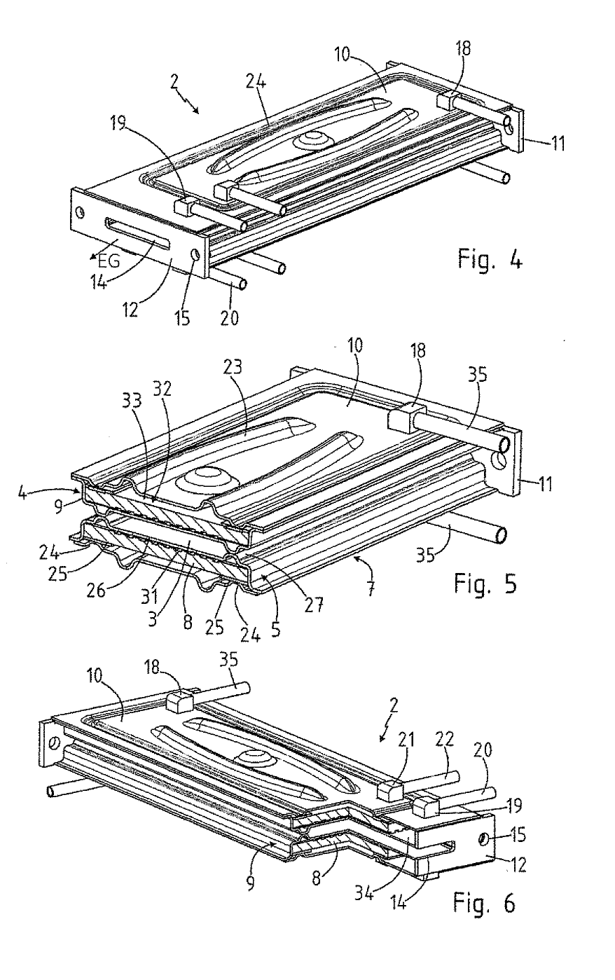

The evaporator 1 illustrated in FIGS. 1-3 differs from the evaporator 2 according to FIGS. 4-6 by the provision of a structure 6 for enlarging the heat transfer surface in the exhaust gas channel 3. The structure 6 for enlarging the heat transfer surface are sheet lamella oriented in the longitudinal direction of the evaporator 2.

Each evaporator cassette 4, 5 has a housing 7. A capillary structure 8 is arranged in the housing 7.

The housing 7 comprises a shell body 9, which is closed by a lid 10 on the opening side. The housing 7 is closed by a front panel 11 and a rear panel 12 on each end face. FIGS. 1 and 3, and FIGS. 4 and 6 show the evaporator 1 or 2, respectively, in a view from the outlet side 13 of the exhaust gas EG. An inlet opening is provided in the form of elongated hole for exhaust gas EG in the front panel 11. The back panel 12 is provided with an outlet opening 14 for the discharge of exhaust gas EG. The outlet opening 14 is also designed as an elongated hole, as shown in FIGS. 3 and 6. The inlet opening, although not shown, is integrated in accordance with the present invention, and is designed analogously to the outlet opening 14. Furthermore, mounting holes 15 are integrated into the front panel 11 and rear panel 12. The parts of the housing 7, that is, in particular the shell body 9, the lid 10 and front panel 11 and rear panel 12, consist of stainless steel.

The shell body 9 has flange sections 17 repositioned outward along its side edges 1.6. The lid 10 rests at the edge on the flange sections 17 and is joined tightly to the shell body 9. A feed 18 for the supply of liquid working medium is integrated into the evaporator cassette 4, 5 in the lid 10. Furthermore, the lid 10 has a vapor outlet 19 with a vapor line 20 as well as an equalization connection 21 for the connection of a vapor equalization line 22. The vapor equalization line 22 is pressure balanced in conjunction with the expansion tank.

Furthermore, beads 23 in the lid 10, which have stabilizing functions, can be seen.

The capillary structure 8 is housed in the shell body 9 and there oriented in position by the lid 10. A peripherally encircling, inwardly directed stamping 24 is provided in the lid 10. The inward stamping 24 forms a pressure zone, over which the lid 10 presses against the capillary structure 8. A temperature-resistant seal 25 is incorporated between inward stamping 24 and capillary structure 8. The seal 25 is designed as a flat seal.

In the bottom 26 of the shell body 9, outward stamped beads 27 are provided on both longitudinal sides in the longitudinal direction of the housing 7 extending outwardly. Two adjacent evaporator cassettes 4, 5 contact each other along the beads 27 and are joined to each other. The exhaust gas channel 3 is formed between two evaporator cassettes 4, 5. The distance between the bottoms 26 of the adjacent evaporator cassettes 4, 5, and thus the size of the exhaust gas channel 3 can be determined via the dimensions of the bead 27. Laterally, the exhaust gas channel 3 is limited by the beads 27 joined to each other. The beads 27 thus form the side walls of the exhaust gas channel 3.

The capillary structure 8 integrated into an evaporator cassette 4, 5 is designed as a porous plate body 28 made of a sintered material, in particular, a metallic material.

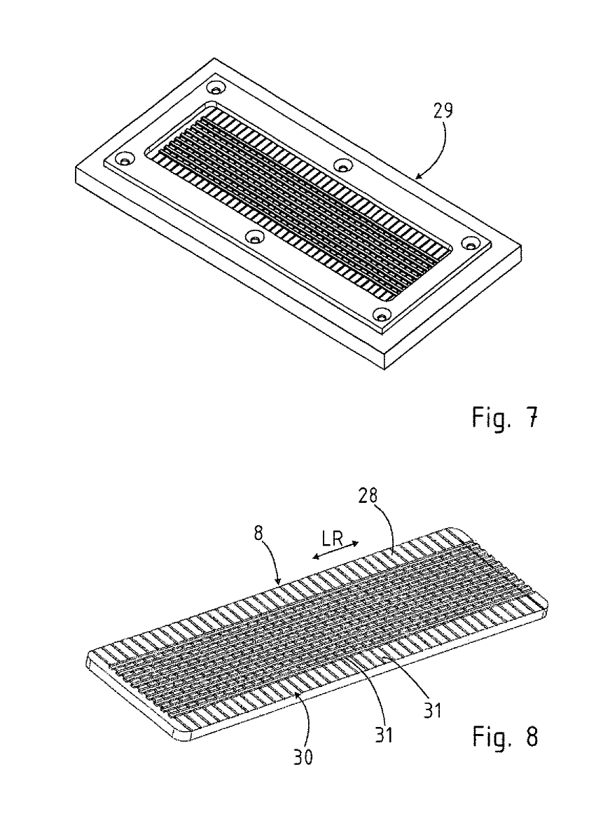

The lower part 29 of a sinter form is shown in FIG. 7. A metal powder is filled as a loose bulk powder in the sinter form and then sintered through temperature influences from the plate body 28 in a closed sintering form.

It can be seen in particular in FIG. 8 that the capillary structure 8 is configured plate-shaped and rectangular. FIG. 8 shows a perspective view on the vapor side 30 of the capillary structure 8. The vapor side 30 is the side of the capillary structure 8 which is arranged adjacent to the bottom 26 of the shell body 9 and the exhaust gas channel 3. Vapor channels 31 running in the longitudinal direction LD of the plate body 28 are integrated into the capillary structure 8. Furthermore, vapor channels 31 are formed transversely.

The liquid working medium is fed to the evaporator cassette 4, 5 via the feed 18 and enters on the liquid side 32 of the evaporator cassette 4, 5. A bounded distribution space 33 is formed here between lid 10 and capillary structure 8 and plate body 28 by the stamping 24 and the seal 25. The liquid working medium is distributed in the distribution space 33 to the liquid side 32 via the surface of the capillary structure 8. The working media is evaporated in the evaporator cassettes 4, 5 by heat transfer from hot exhaust gas EG flowing through the exhaust gas channel 3. The working medium flows through from the liquid side 32 through the capillary structure 8 and crosses over from a fluid into a vaporous state. The phase boundary between the liquid and vapor during operation of the evaporator 1, 2 takes place in the capillary structure 8, through which capillary pressure is built up, which causes or rather guarantees the circulation of the working medium. The vaporous working medium flows through vapor channels 31 on the vapor side 30 until it enters respectively into a vapor collector 34. Each evaporator cassette 4, 5 has a vapor collector 34. The vaporous working medium is discharged from the vapor collectors 34 respectively via the vapor outlet 19 and the vapor line 20 and led to the condenser.

Heat from the vaporous working medium is given off to a consumer in the condenser. In particular, the condenser can be part of a heating device of the motor vehicle, for example, the interior heating. Also, the condenser can be part of a climate module of an air conditioner of the motor vehicle. A consequence of the heat release, the vaporous working medium is liquefied in the condenser and flows preferably gravity-driven via a feed line 35, which is connected to the feed 18, back into the evaporator 1, 2 or the evaporator cassettes 4, 5, where the fluid working medium enters again via the feed 18.

While the invention has been illustrated and described in connection with currently preferred embodiments shown and described in detail, it is not intended to be limited to the details shown since various modifications and structural changes may be made without departing in any way from the spirit and scope of the present invention. The embodiments were chosen and described in order to explain the principles of the invention and practical application to thereby enable a person skilled in the art to best utilize the invention and various embodiments with various modifications as are suited to the particular use contemplated.

What is claimed as new and desired to be protected by Letters Patent is set forth in the appended claims and includes equivalents of the elements recited therein:

What is claimed is:

1. A motor vehicle heat exchanger system, comprising:
a closed circuit for a working medium;
an exhaust gas channel configured to conduct exhaust gas from an internal combustion engine of a motor vehicle; and
an evaporator configured to contact the exhaust gas channel for evaporating the working medium, said evaporator comprising at least one evaporator cassette which includes a housing and a capillary structure arranged in the housing.

2. The motor vehicle heat exchanger system of claim 1, wherein the at least one evaporator cassette has a liquid side and a vapor side, which are separated by the capillary structure.

3. The motor vehicle heat exchanger system of claim 1, wherein the capillary structure is formed by a porous plate body.

4. The motor vehicle heat exchanger system of claim 1, wherein the capillary structure is made of sintered material.

5. The motor vehicle heat exchanger system of claim 1, wherein the capillary structure has formed therein vapor channels.

6. The motor vehicle heat exchanger system of claim 5, wherein the vapor channels are arranged in a surface of the capillary structure facing the exhaust gas channel.

7. The motor vehicle heat exchanger system of claim 1, wherein the evaporator cassette has a distribution space for liquid working medium.

8. The motor vehicle heat exchanger system of claim 1, wherein the evaporator cassette includes a vapor collection chamber.

9. The motor vehicle heat exchanger system of claim 1, wherein the evaporator comprises a plurality of said evaporator cassette.

10. The motor vehicle heat exchanger system of claim 9, wherein the exhaust gas channel is formed between two of the evaporator cassettes.

11. The motor vehicle heat exchanger system of claim 1, further comprising a structure received in the exhaust gas channel to enlarge a heat transfer surface.

12. The motor vehicle heat exchanger system of, wherein the housing includes a shell body and a lid to close the shell body.

13. The motor vehicle heat exchanger system of claim 1, wherein the housing includes beads and/or inward or outward stampings.

14. The motor vehicle heat exchanger system of claim 1, wherein the capillary structure is arranged in the housing, and further comprising seals to seal the capillary structure against the housing.

15. The motor vehicle heat exchanger system of claim 1, wherein the evaporator is configured for pressure equalization.

16. The motor vehicle heat exchanger system of claim 1, further comprising an expansion tank, arranged upstream of the evaporator, for the working medium.

17. The motor vehicle heat exchanger system of claim 1, wherein the housing of the evaporator cassette has vapor grooves formed by beads.
